(19) United States
(12) Patent Application Publication
(10) Pub. No.: US 2025/0355793 A1
(43) Pub. Date: Nov. 20, 2025

(54) TOUCHLESS DEVICE MANAGEMENT

(71) Applicant: Microsoft Technology Licensing, LLC, Redmond, WA (US)

(72) Inventors: Rathi KARTHEEK, Cupertino, CA (US); Vikas AHLUWALIA, Redmond, WA (US); Dan IATCO, Redmond, WA (US); Joseph Thomas FARRO, Puyallup, WA (US); Ying HUANG, Sammamish, WA (US); Damon Kayne HUNKA, Redmond, WA (US); Francisco Cantú de la GARZA, Sammamish, WA (US); Trung Can Thai VO, Renton, WA (US)

(21) Appl. No.: 18/667,743

(22) Filed: May 17, 2024

(51) Int. Cl. G06F 11/36

(52) U.S. Cl. CPC G06F 11/3698; G06F 11/3648

(57) ABSTRACT

Touchless device management allows devices to be operated remotely from any location for any purpose, including demonstration, teaching, product development, testing, debugging, and repairing, increasing productivity with 24 hours access around the world and reducing costs associated with device production, travel, and shipping. Remote operations include modifying firmware and software, power up/down, booting, simulating user operation of internal and external input devices (e.g., using command line instructions and/or automated scripts), running a debugger during operation, etc. A touchless device manager includes a user interface, a controllable device selector, a hardware identifier, a firmware and software mapper, a firmware and software configurer, a firmware and software modifier, a control script developer and selector, a device controller, and a debugger. A device controller attached to a controllable device includes a user input emulator, a communication bus emulator, an external device emulator, and a remote control interface.

### BACKGROUND

Device management enables entities (e.g., individual users, organizations, etc.) to administer and maintain devices, including virtual machines, physical computers, mobile devices, and IoT (Internet of Things) devices. In an organizational environment, device management helps ensure that devices are secure, up-to-date, and compliant with organizational policies, with the goal of protecting the corporate network and data from unauthorized access.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for touchless device management. A controller is configured to control hardware signals of a controllable device. The controller includes network access or is attached to a local host/agent computing device with network access for remote control by a remote host. The remote host is enabled to operate the controllable device and perform various device management functions. Remote operation by the remote host includes generating signaling that simulates a user operating internal and external input devices of the controllable device. The remote host displays video of the controllable device and controller provided by a camera coupled to the local host/agent device, providing complete interaction.

In one aspect, a computing device controller comprises: a connector configured to connect the computing device controller to a controllable device; a user input emulator configured to generate signals to emulate user input through a first set of (e.g., external) human interface devices (HIDs) associated with the controllable device; a communication bus emulator configured to receive and transmit signals (e.g., control signals, data signals) on at least one communication bus in the controllable device via the connector, at least one of the transmitted signals emulating user input through a second set of (e.g., internal) HIDs associated with the controllable device; an external device emulator configured to emulate connection of an external device (e.g., USB key) to a communication interface of the controllable device; and a remote control interface configured to receive and transmit signals for remote monitoring and control of the controllable device, the signals comprising control signals provided to the user input emulator and the communication bus emulator for the emulation of the user input through the first and second HIDs.

In another aspect, a method comprises enabling remote control of a controllable device by a remote computing device through a device controller coupled to the controllable device to enable the remote computing device to remotely perform: mapping firmware and software associated with the controllable device; identifying a signal in the controllable device to control; configuring the device controller to control the identified signal; modifying firmware of a component of the controllable device by controlling the identified signal; modifying software of the controllable device; and operating the controllable device.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example computing environment for touchless device management, according to an embodiment.

FIG. 2 shows a block diagram of an example computing environment for touchless device management, according to an embodiment.

FIG. 3 shows a block diagram of an example computing environment for touchless device management, according to an embodiment.

FIG. 4 shows an example of components in touchless device manager, according to an example embodiment.

FIGS. 5A-5C show flowcharts of example methods for implementing touchless device management, according to embodiments.

FIG. 6 shows a block diagram of example computing devices that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

Device development, testing, and utilization often require devices and personnel to be collocated, which usually entails higher production quantities and transportation of the devices and/or personnel. Complex devices involving personnel collaborating together from multiple locations around the world may lead to significant delays and expenditures for increased production quantities, shipping, travel, and so on. Large, bulky, and/or fragile devices may require extra care, delay, and cost to move to various locations. Further, device and personnel relocations for limited periods of time with devices reduce productivity and stress personnel.

As described herein, a reusable hardware interface (e.g., for multiple devices in contrast to a device-specific test harness) can be configured to enable remote interaction with computing devices, which significantly reduces costs and delays involved in device design, improvement, test production quantities, testing, debugging, recovery, demonstration, general use, control, management, etc. Remote control access to devices supports 24 hour continuous operation, testing, debugging, etc. during normal business hours in different locations around the world. The reusable hardware interface can be used with hardware automated test suites. Automated Test suites can provide continual validation of customer experience. Automated Test suites can free-up developer time from non-critical functions.

The reusable hardware interface can emulate customer control by generating signals and injecting them into the remotely controlled device. For example, the reusable hardware interface can provide an ability to remotely perform the following operations on a controlled device: human interface device (HID) simulation (e.g., keyboard, mouse, trackpad, touch screen), button control, keyboard support, mouse support, communication interface (e.g., USB) support, screen validation, camera support, firmware (FW) updates (e.g., flashing FW), monitoring FW trace, operating system (OS) updates, hardware automation, signal monitoring (e.g., I2C, UART, SPI bus signals), probing signal levels, debugging (e.g., through JTAG), remote access, power stress testing, etc.

Accordingly, methods, systems, and computer program products are provided for touchless device management. A device can be operated remotely, including signaling that simulates a user operating internal and external input devices, from any location for any purpose, including demonstration, teaching, product development, testing, debugging, and repairing, thereby reducing costs associated with device production, travel, and shipping. Configuration for remote control includes configuring the controller to control hardware signals of the controllable device (e.g., by mapping connector pins, configuring signal translation (e.g., from universal serial bus (USB) to Universal Asynchronous Receiver Transmitter (UART), serial peripheral interface (SPI), inter-integrated circuit (I2C) signals) and voltage level shifting of signals. Firmware and software can be mapped for a variety of controllable devices. The controller includes network access or is attached to a local host/agent computing device with network access for remote control. A remote host can modify firmware, update software, power up, power down, boot, and operate the controllable device (e.g., with command line instructions and/or automated scripts), run a debugger during operation, etc. The remote host can display video of the controllable device and device controller provided by a camera coupled to the local host/agent device, providing complete interaction.

In one aspect, a computing device controller comprises: a connector configured to connect the computing device controller to a controllable device; a user input emulator configured to generate signals to emulate user input through a first set of (e.g., external) human interface devices (HIDs) associated with the controllable device; a communication bus emulator configured to receive and transmit signals (e.g., control signals, data signals) on at least one communication bus in the controllable device via the connector, at least one of the transmitted signals emulating user input through a second set of (e.g., internal) HIDs associated with the controllable device; an external device emulator configured to emulate connection of an external device (e.g., USB key) to a communication interface of the controllable device; and a remote control interface configured to receive and transmit signals for remote monitoring and control of the controllable device, the signals comprising control signals provided to the user input emulator and the communication bus emulator for the emulation of the user input through the first and second HIDs. By emulating user input via the first and second sets of HIDs, operation of the controllable device in its intended environment can be emulated, therefore enabling device management, debugging, etc., to be performed automatically and continuously and with greater speed and accuracy (e.g., versus manual operation). The use of the first and second HIDs enables a full range of emulated user input types, including external (e.g., keyboard, mouse) (coupled by wire or wireless communication links) and internal (e.g., touchpad, touch screen) (integrated in the controllable device).

In another aspect, a method comprises enabling remote control of a controllable device by a remote computing device through a device controller coupled to the controllable device to enable the remote computing device to remotely perform: mapping firmware and software associated with the controllable device; identifying a signal in the controllable device to control; configuring the device controller to control the identified signal; modifying firmware of a component of the controllable device by controlling the identified signal; modifying software of the controllable device; and operating the controllable device.

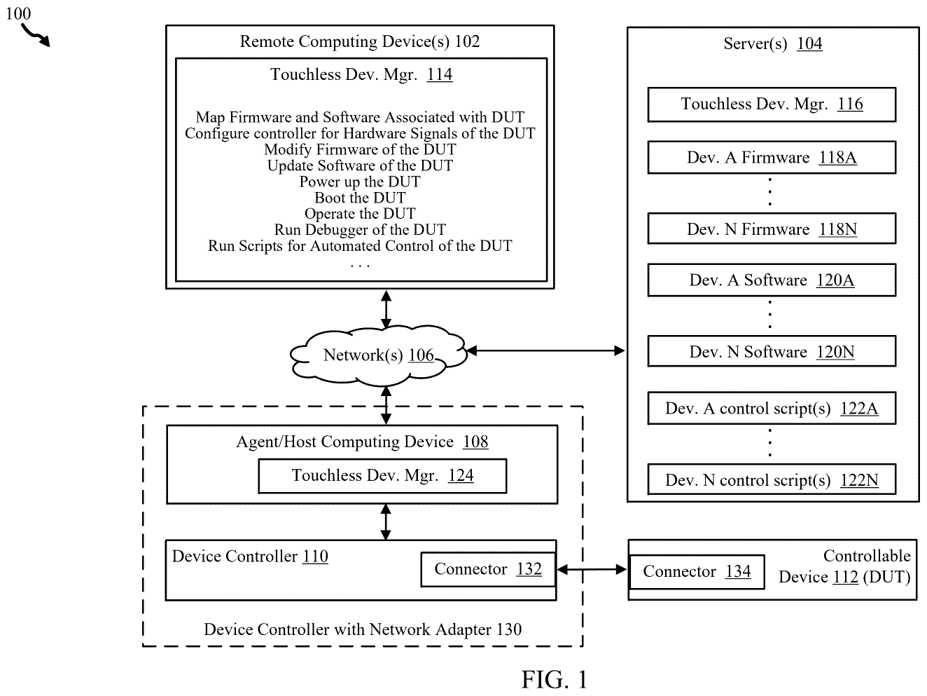

These and further embodiments may be configured in various ways and implemented in a variety of systems/environments. For example, FIG. 1 shows a block diagram of an example computing environment 100 for touchless device management, according to an embodiment. Example computing environment 100 presents one of many possible examples of computing environments. As shown in FIG. 1, computing environment 100 includes one or more remote computing devices 102, one or more servers 104, an agent/host computing device 108, a device controller 110, and a controllable device 112. Remote computing device(s) 102 includes a touchless device manager 114. Server(s) 104 includes a touchless device manager 116, one or more of device A-N firmware 118A-118N, one or more of device A-N software 120A-120N, and one or more of device A-N control scripts 122A-122N. Agent/host computing device 108 includes a touchless device manager 124. Device controller 110 includes a connector 132. Controllable device 112 includes a connector 134. These components of environment 100 are described in further detail as follows.

As shown in FIG. 1, remote computing device(s) 102, server(s) 104, agent/host computing device 108, and device controller 110 are communicatively coupled by one or more networks 106 in support of remote control of controllable device 112. Network(s) 106 may include one or more public access and/or restricted (e.g., private) access networks, which may be wired and/or wireless. Network(s) 136 may include, for example, one or more of any of a local area network (LAN), a wide area network (WAN), a personal area network (PAN), a combination of communication networks, such as the Internet, and/or a virtual network. In an implementation, remote computing device(s) 102, server(s) 104, and agent/host computing device 108 communicate via one or more application programming interfaces (APIs), and/or according to other interfaces and/or techniques. Remote computing device(s) 102, server(s) 104, and agent/host computing device 108 include one or more network interfaces that enable communications between devices. Examples of such a network interface, wired or wireless, may include, for example, an IEEE 602.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

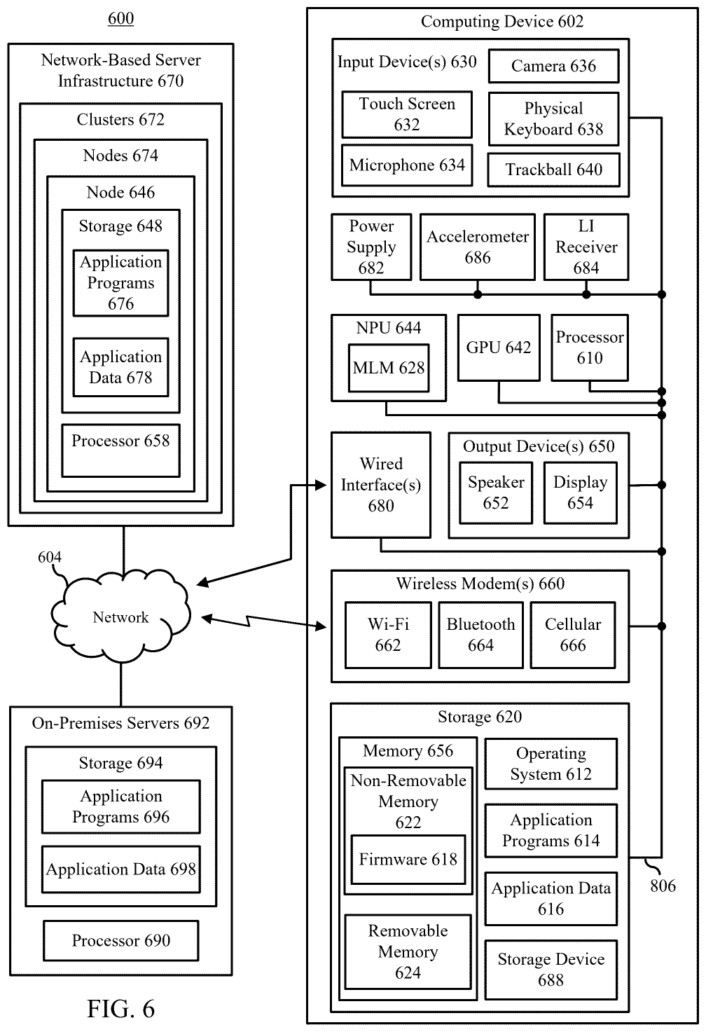

Remote computing device(s) 102 may be any type of stationary or mobile computing device, including a mobile computer or mobile computing device (e.g., a personal digital assistant (PDA), a laptop computer, a notebook computer, a tablet computer, a netbook, etc.), a mobile phone, a wearable computing device, or other type of mobile device, or a stationary computing device such as a desktop computer or PC (personal computer), or a server. Computing device 102 may include one or more applications, operating systems, virtual machines (VMs), storage devices, etc., that may be executed, hosted, and/or stored therein or via one or more other computing devices via network(s) (not shown). An example computing device with example features is presented in FIG. 6.

Remote computing device(s) 102 may execute one or more processes in one or more computing environments. A computing environment may be any computing environment (e.g., any combination of hardware, software, and firmware). A process is any type of executable (e.g., binary, program, application) that is being executed by a computing device. A process executed by computing device 102 may include a touchless device manager 114 configured to control controllable device 112. In various implementations, touchless device manager 114 (as a process) may operate in concert with (e.g., communicate with) touchless device manager 124 (as a process of agent/host computing device 108) and/or touchless device manager 116 (as a process of server(s) 104). Touchless device manager 114 may include a user interface for users to create, store, and access firmware, software, and control programs (e.g., scripts) for one or more controllable devices, e.g., device A-N firmware 118A-118N, device A-N software 120A-120N, device A-N control scripts 122A-122N, which may be stored and retrieved with release version control.

Remote computing device(s) 102 shows examples of operations that users may perform remotely on controllable device (e.g., DUT) 112 via remote computing device(s) 102, such as one or more of the following: map firmware and software associated with DUT 112; configure device controller 110 for hardware signals of the DUT 112; modify firmware of the DUT 112; update software of the DUT 112; power up/down the DUT 112; (re) boot the DUT 112; operate the DUT 112; run a debugger of the DUT 112; run scripts for automated control of the DUT 112, etc.

Server(s) 104 may comprise one or more computing devices, servers, services, local processes, remote machines, web services, etc. Server(s) 104 may be any type of stationary or mobile computing device. In an example, server(s) 104 may comprise a server located on an organization's premises and/or coupled to an organization's local network, a remotely located (e.g., third party) server, a cloud-based server (e.g., one or more servers in a distributed manner), or any other device or service that may host, manage, and/or provide resource(s) for touchless device management. Server(s) 104 may be implemented as a plurality of programs executed by one or more computing devices. Server(s) 104 is not limited to physical machines, but may include other types of machines or nodes, such as a virtual machine, that are executed in physical machines.

Server(s) 104 may execute one or more processes related to touchless device management of controllable device 112. A process executed by server(s) 104 may include a touchless device manager 116 configured to control controllable device 112. In various implementations, touchless device manager 116 (as a process of server(s) 104) may operate in concert with (e.g., communicate with) touchless device manager 114 (as a process of remote computing device(s) 102) and/or touchless device manager 124 (as a process of agent/host computing device 108). For example, touchless device manager 116 may be a WebApp accessed by users of remote computing device(s) 102 to control controllable device 112. Touchless device manager 116 may include a user interface for users to create, store, and access firmware, software, and control programs (e.g., scripts) for one or more controllable devices, e.g., device A-N firmware 118A-118N, device A-N software 120A-120N, device A-N control scripts 122A-122N, which may be stored and retrieved with release version control.

Agent/host computing device 108 may be any type of stationary or mobile computing device, including a mobile computer or mobile computing device (e.g., a Microsoft® Surface® device, a personal digital assistant (PDA), a laptop computer, a notebook computer, a tablet computer, a netbook, etc.), a mobile phone, a wearable computing device, or other type of mobile device, or a stationary computing device such as a desktop computer or PC (personal computer), or a server. Agent/host computing device 108 may include one or more applications, operating systems, virtual machines (VMs), storage devices, etc., that may be executed, hosted, and/or stored therein or via one or more other computing devices via network(s) (not shown). An example computing device with example features is presented in FIG. 6.

Agent/host computing device 108 may be separate from or integrated with device controller 110. Agent/host computing device 108 integrated with device controller 110 may be referred to as a device controller with a network adapter 130, e.g., as indicated by the dashed box in FIG. 1.

Agent/host computing device 108 may be accessed by remote computing device(s) 102 and/or server(s) 104 via network(s) 106. In some examples, agent/host computing device 108 may run a Microsoft Windows® operating system with remote desktop functionality. Remote desktop may be enabled on agent/host computing device 108 with user(s) of remote computing device(s) 102 being authorized users.

Agent/host computing device 108 may execute one or more processes related to touchless device management of controllable device 112. A process executed by agent/host computing device 108 may include a touchless device manager 124 configured to control controllable device 112. In various implementations, touchless device manager 124 (as a process of agent/host computing device 108) may operate in concert with (e.g., communicate with) touchless device manager 114 (as a process of remote computing device(s) 102) and/or touchless device manager 116 (as a process of server(s) 104). For example, touchless device manager 124 may be an agent of touchless device manager 114 and/or touchless device manager 116. Touchless device manager 124 may include a user interface for users to create, store, and access firmware, software, and control programs (e.g., scripts) for one or more controllable devices, e.g., device A-N firmware 118A-118N, device A-N software 120A-120N, device A-N control scripts 122A-122N, which may be stored and retrieved with release version control.

Device controller 110 is a reusable hardware interface (e.g., for multiple controllable devices 112, in contrast to a device-specific test harness). Device controller 110 is configurable to enable remote interaction with controllable device 112. Device controller 110 can be used with touchless device manager 114, 116, and/or 124, as well as device A-N firmware 118A-118N, device A-N software 120A-120N, device A-N control scripts 122A-122N for remote operation of controllable device 112.

Device controller 110 be configured (e.g., by device A-N control scripts 122A-122N) to emulate user control of controllable device 112 by receiving, translating, and/or generating signals and injecting them into controllable device 112. For example, device controller 110 is configurable to perform the following operations on controllable device 112: human interface device (HID) simulation (e.g., keyboard, mouse, trackpad, touch screen), button control, keyboard support, mouse support, communication interface (e.g., USB) support, screen validation, camera support, firmware (FW) updates (e.g., flashing FW), monitoring FW trace, operating system (OS) updates, hardware automation, signal monitoring (e.g., I2C, UART, SPI bus signals), probing signal levels, debugging (e.g., through JTAG), remote access, power stress testing, etc.

Device controller 110 includes a connector 132 configured to connect the computing device controller to a controllable device. Device controller 110 includes a user input emulator configured to generate signals to emulate user input through a first set of input devices (e.g., external mouse, keyboard, stylus, game controller) associated with controllable device 112. Device controller 110 includes a communication bus emulator configured to receive and transmit signals on at least one communication bus in controllable device 112 via connector 132. One or more of the transmitted signals can emulate user input through a second set of input devices associated with controllable device 112 (e.g., internal/integrated HIDs, such as trackpad, touchscreen, keyboard). Device controller 110 includes an external device emulator configured to emulate connection of an external device (e.g., USB key) to a communication interface of controllable device 112. Device controller 110 includes a remote control interface (e.g., USB to agent/host computing device 108 and to controllable device 112) configured to receive and transmit signals for remote monitoring and control of controllable device 112. The signals can include data and control signals provided to the user input emulator and the communication bus emulator for the emulation of the user input through the first and second sets of input devices.

Controllable device 112 may be any type of stationary or mobile computing device, including a mobile computer or mobile computing device (e.g., a Microsoft® Surface® device, a personal digital assistant (PDA), a laptop computer, a notebook computer, a tablet computer, a netbook, etc.), a mobile phone, a wearable computing device, or other type of mobile device, or a stationary computing device such as a desktop computer or PC (personal computer), or a server. Controllable device 112 may include one or more applications, operating systems, virtual machines (VMs), storage devices, etc., that may be executed, hosted, and/or stored therein or via one or more other computing devices via network(s) (not shown). An example controllable device 112 with example features is presented in FIG. 6. Controllable device 112 may be referred to as a device under test (DUT), irrespective of whether controllable device 112 is being tested.

Controllable device 112 includes one or more internal communication buses configured with one or more connectors 134 that may be used to interface with device controller 110. Communication protocols for accessible buses may include, for example, one or more of the following: USB, I2C, SPI, and/or UART. Controllable device 112 includes one or more communication interfaces (e.g., connectors for USB, HDMI, Ethernet, power, etc.) that may be used to interface with device controller 110.

Each controllable device 112 may have one or multiple supported configurations/computing environments (e.g., hardware, firmware, software, connected devices, network connections, and so on), which may be mapped to device A-N firmware 118A-118N, device A-N software 120A-120N, and device A-N control scripts 122A-122N.

Controllable device 112 can be controlled through device controller 110 by any one or more of agent/host computing device 108, remote computing device(s) 102, and/or server(s) 104. For example, agent/host computing device 108, remote computing device(s) 102, and/or server(s) 104 can execute typed commands and/or control scripts associated with controllable device 112 (e.g., device A-N control scripts 122A-22N) to provide instruction to device controller 110 to monitor and/or control operation of controllable device 112.

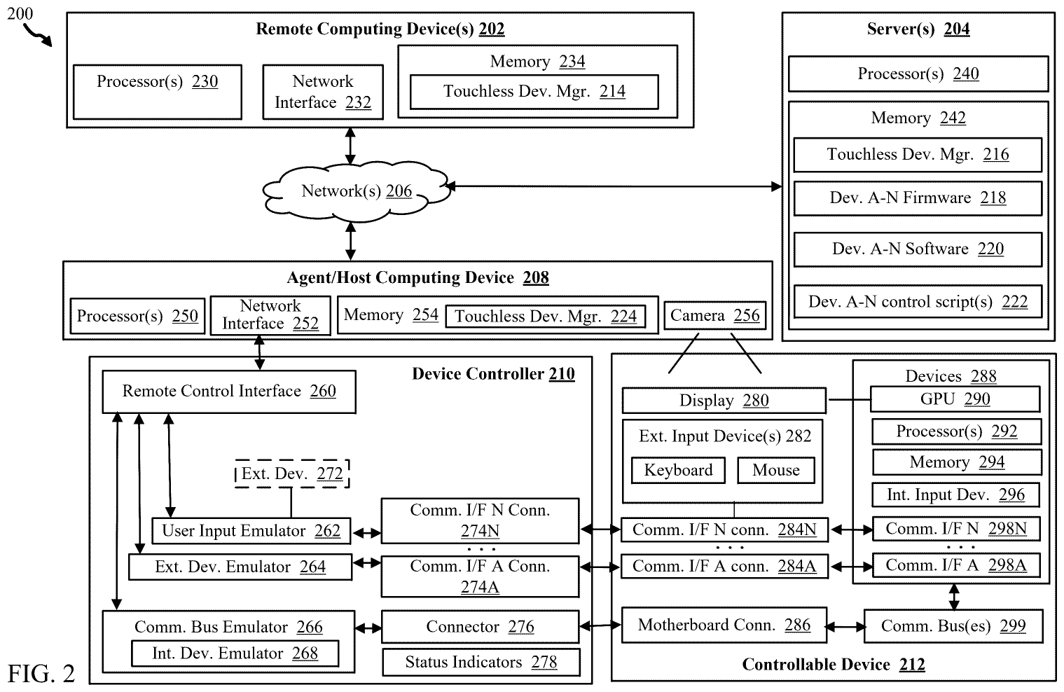

FIG. 2 shows a block diagram of an example computing environment 200 for touchless device management, according to an embodiment. Example computing environment 200 presents one of many possible examples of computing environments. As shown in FIG. 2, computing environment 200 includes one or more remote computing devices 202, one or more servers 204, an agent/host computing device 208, a device controller 210, and a controllable device (also known as controllable device) 212. These and further components of environment 200 are described in further detail as follows.

As shown in FIG. 2, remote computing device(s) 202, server(s) 204, and agent/host computing device 208 are communicatively coupled by one or more networks 206 in support of remote control of controllable device 212.

Remote computing device(s) 202 includes one or more processors 230, a network interface 232, and a memory 234. Processor(s) 230 execute program code stored in a computer readable medium (e.g., memory 234), such as program code of an operating system with remote access and one or more applications, including touchless device manager 214. Processor(s) 230 include any type of processing unit. Processor 230 may be, for example, a central processing unit (CPU), a microcontroller, a microprocessor, and/or other physical hardware processor circuit. Processes executed by processor(s) 230 include(s) an operating system (e.g., with remote access), a touchless device manager 214, one or more device A-N control scripts 222, etc., to remotely configure and/or operate controllable device 212 through network interface 232 and network(s) 206.

Server(s) 204 includes one or more processors 240, a network interface (not shown), and memory 242. Processor(s) 240 execute program code stored in a computer readable medium (e.g., memory 242), such as program code of an operating system with remote access and one or more applications, including a touchless device manager 216. Processor(s) 240 include any type of processing unit. Processor 240 may be, for example, a central processing unit (CPU), a microcontroller, a microprocessor, and/or other physical hardware processor circuit. Processes executed by processor(s) 240 include(s) an operating system (e.g., with remote access), touchless device manager 216, device A-N firmware 218, device A-N software 220, one or more device A-N control scripts 222, etc., to remotely configure and/or operate controllable device 212 through a network interface (not shown) and network(s) 206.

Agent/host computing device(s) 208 includes one or more processors 250, a network interface 252, a memory 254, and a camera 256. Processor(s) 250 execute program code stored in a computer readable medium (e.g., memory 254), such as program code of an operating system with remote access and one or more applications, including touchless device manager 224. Processor(s) 250 include any type of processing unit. Processor 250 may be, for example, a central processing unit (CPU), a microcontroller, a microprocessor, and/or other physical hardware processor circuit. Processes executed by processor(s) 250 include(s) an operating system (e.g., with remote access), a touchless device manager 224, one or more device A-N control scripts 222, etc., to remotely configure and/or operate controllable device 212.

Device controller 210 includes remote control interface 260, user input emulator 262, external device emulator 264, communication bus emulator 266, camera 270, an external device 272, communication interface (I/F) A-N connectors 274A-274N, and connector 276.

Controllable device 212 includes a display 280, one or more external input devices 282, one or more communication interface A-N connectors 284A-284N, a motherboard connector 286, and one or more devices (e.g., and components) 288, such as a GPU device 290, one or more processor devices 292, one or more memory devices 294, one or more internal/integrated input devices 296, one or more communication interface devices A-N 298A-298N, and one or more communication buses 299.

Agent/host computing device(s) 208 can communicate with remote computing device(s) 202 and/or server(s) 204 through network interface 252 and network(s) 206, for example, to provide and/or receive information in support of remote monitoring and control of controllable device 212. For example, agent/host computing device 208 may receive instructions to configure and/or operate device controller 210 and/or controllable device 212, monitor and/or control signals in device controller 210 and/or controllable device 212, etc. In some examples, processor(s) 250 executes a state machine that controls the state of device controller 210. The state machine may result from processing touchless device manager 224 and/or one or more scripts 222 associated with control of controllable device 212.

Camera 256 can be any type of camera, e.g., internal or external camera, that is configured to provide a video feed of controllable device 212 to remote computing device(s) 202. For example, camera 256 may be an external camera coupled to a USB or HDMI connector of agent/host computing device 208. Camera 256 may be positioned to capture display 280 of controllable device 212 and/or status indicators 278 of device controller.

Remote control interface 260 of device controller 210 is a communication interface that communicatively couples device controller 210 to agent/host computing device 208 with network interface 252 or otherwise supports remote access and control of device controller 210. For example, remote control interface 260 may be a USB (e.g., USB-C) protocol interface. Remote control interface 260 may be configured to receive and transmit signals for remote monitoring and control of controllable device 212. The signals can be, for example, data and control signals provided to and/or received from user input emulator 262, external device emulator 264, and communication bus emulator 266. Control signals provided through remote control interface 260 to user input emulator 262 may support emulation of user input through a first set of input devices (e.g., external input device(s) 282) of controllable device 212. Control signals provided through remote control interface to communication bus emulator 266 may support emulation of user input through a second set of input devices (e.g., internal input device(s) 296) of controllable device 212. and second (e.g., internal and external) sets of input devices of controllable device 212.

User input emulator 262 may be configured to generate signals to emulate user input through a first set of input devices associated with the controllable device. As shown by example in FIG. 2, communication interface N connector 274N (e.g., USB) of device controller 210 may be connected to communication interface N connector 284N (e.g., USB) of controllable device 212. For example, user input emulator 262 may emulate user operation of external HIDs, such as an external keyboard and mouse. Signals generated by user input emulator 262 may be provided to controllable device 212, for example, through a USB interface. User input emulator 262 may be implemented by, for example, a microprocessor.

External device emulator 264 may be configured to emulate connection of external device 272 to a communication interface of controllable device 212. In this manner, various external devices may be coupled to controllable device 212 through device controller 210 such that access to their functionality may be controlled by device controller 210 with respect to controllable device 212. As shown by example in FIG. 2, communication interface A connector 274A (e.g., USB) of device controller 210 may be connected to communication interface A connector 284A (e.g., USB) of controllable device 212. For example, external device emulator 264 may emulate a USB key inserted into a USB interface connector of controllable device 212. External device emulator 264 may emulate insertion of a USB key storing device A-N software 220, such as an operating system. Processor(s) 250 may execute the appropriate script among device A-N control scripts to control controllable device 212 to install or to boot from the operating system (OS) stored on external device 272 that may actually be inserted in device controller 210. For instance, device controller 210 may control controllable device 212 to boot from the OS of external device 272 before performing further functionality with respect to controllable device 212 that depends on that particular OS. Command line or script instructions could be, for example, a remote image update causing controllable device 212 to flash a new OS on controllable device 212 to implement the remote image update.

One or more of external device 272 may be present that each are any type of device that could be inserted into a communication interface of controllable device 212. Examples of external device 272 includes devices external to controllable device 212, such as removable external user interface devices (e.g., touchpads, keyboards, touch screens, pointing devices, storage devices, display screens, game controllers, speakers), portable storage devices, cameras, and so on. External device(s) 272 can be collocated (e.g., and locally connected) with device controller 272 or remote (e.g., by wired or wireless connection). In some examples, external device 272 may be a USB key, which could be a flash memory based USB drive, a security device used to identify and/or authenticate a user, a transceiver for wireless communication with wireless devices, etc.

Communication bus emulator 266 may be configured to receive and transmit signals (e.g., control signals, data signals) on at least one communication bus in controllable device 212 via the connector 276. As shown by example in FIG. 2, communication bus emulator 266 may be communicatively coupled to a motherboard connector 286 of controllable device 212. Communication bus emulator may translate signals from one or more bus protocol signals to one or more other bus protocol signals. For example, communication bus emulator 266 may translate between USB protocol signals received from/provided to agent/host computing device 208 to I2C, SPI, and UART protocols provided to/received from controller device 212 via connector 276. One or more of the transmitted signals can be configured to emulate user input through a second set of input devices associated with controllable device 212. For example, communication bus emulator 266 can include internal device emulator 268, which may emulate a user using one or more internal/integrated HIDs, such as a keyboard, trackpad, touchscreen, power button, etc.

Communication interface (I/F) A-N connectors 274A-274N include any type of wired or wireless communication protocol interface (e.g., with a wired or wireless connection) that can be used to communicatively couple to controllable device 212. For example, communication interface (I/F) A-N connectors 274A-274N can be Universal Serial Bus (USB) interface (e.g., USB-C, USB-A), HDMI, Bluetooth™ interface, near field communication (NFC) interface, an Ethernet interface, and so on.

Connector 276 may be configured to connect the device controller 210 to the controllable device 212. For example, connector 276 may connect to one or more connectors on a motherboard of controllable device 212 (e.g., motherboard connector 286).

Status indicators 278 may be configured to indicate to local and/or remote users the status of device controller 210. Status indicator 278 may be any type of indicator, such as audible, visual, electronic signals (e.g., flags), etc. Status indications may be provided to remote computing device(s) 202 in the form of signals or as part of a video stream captured by camera 270.

Display 280 of controllable device 212 is configured to display information associated with controllable device 212. Display 280 is configured to display information generated by GPU 290. Display 280 may be internal to (e.g., integrated in) or external to controllable device 212. Display 280 may be any type of display device, such as CRT, OLED, AMOLED, LCD, IPS-LCD, etc.

External input devices 282 include devices that are not integrated in controllable device 212, such as a wired or wireless keyboard and/or mouse communicatively coupled to controllable device 212 by wireless or wired communication interface connection 284A-N.

Communication interface A-N connectors 284A-284N include any type of wired or wireless communication protocol interface connection that communicatively couples controllable device 212 to device controller 212, network(s) 206, etc. For example, communication interface (I/F) A-N connectors 284A-284N can include Universal Serial Bus (USB) interface connectors (e.g., USB-C, USB-A connectors), HDMI connectors, Bluetooth™ interface wireless connections, near field communication (NFC) wireless interface connections, an Ethernet connector or WiFi wireless interface connector, and so on.

Motherboard connector 286 provides connection to one or more communication bus(es) 299 on a motherboard that connects devices and components 288 in controllable device 212. Motherboard connector 286 provides access to hardware signals for monitoring and control of controllable device 212, which access device controller 210 uses to emulate buses 299 and devices 288 as needed to control controllable device 212.

Devices 288 include devices and components in controllable device 212 communicatively coupled by communication bus(es) 299. Devices and components 288 include devices shown and other devices and components (e.g., touchpads, keyboards, touch screens, display screens, pointing devices, storage devices, game controllers, speakers), cameras, active heat dissipation devices (e.g., fans, coolant pumps and radiators), and so on.

GPU 290 is a graphics processing unit configured to process graphics and render video to display 280. GPU 108 may be separate from or integrated with processor(s) 106 (e.g., on a board/card).

Processor(s) 292 execute program code stored in a computer readable medium (e.g., memory 294), such as program code of an operating system with remote access and one or more applications. Processor(s) 292 include any type of processing unit. Processor 292 may be, for example, a central processing unit (CPU), a microcontroller, a microprocessor, and/or other physical hardware processor circuit.

Memory 294 is one or more types of computer-readable mediums. Memory 294 includes one or more types of memory, such as read only memory (ROM) 608 and random-access memory (RAM) 610. Memory 294 stores an operating system, applications, and data (e.g., files) accessed (e.g., and executed) by processor(s) 292.

Internal input devices 296 include input devices integrated in controllable device 212, such as a touchscreen (e.g., with a digital touch keyboard), a trackpad, a power button, a volume button, a keyboard, etc., which may vary in a variety of types of controllable device 212.

Communication interfaces A-N 298A-298N include any type of wired or wireless communication protocol interface (e.g., with a wired or wireless connection) that can be used to communicatively couple to controllable device 212. For example, communication interface (I/F) A-N connectors 298A-298N can be Universal Serial Bus (USB) interface (e.g., USB-C, USB-A), HDMI, Bluetooth™ interface, near field communication (NFC) interface, an Ethernet interface, a WiFi interface, and so on.

Communication bus(es) 299 may be implemented, for example, on a motherboard (not shown) that connects devices 288 in controllable device 212. Communication bus(es) 299 communicate hardware signals between devices 288. Device controller 210 can receive and transmit signals on communication bus(es) 299 through motherboard connector 286 and connector 276 to perform monitoring and control of controllable device 212, e.g., in addition to receiving and transmitting information via communication interface connections 274A-N to 284A-N.

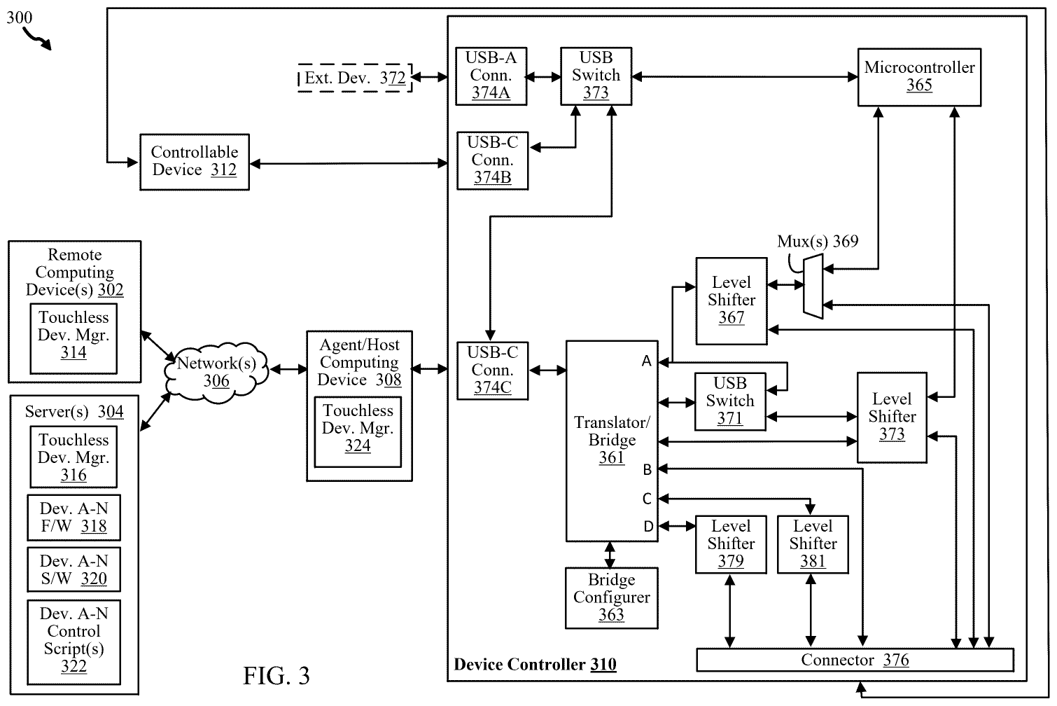

FIG. 3 shows a block diagram of an example computing environment 300 for touchless device management, according to an embodiment. Example computing environment 300 presents one of many possible examples of computing environments. As shown in FIG. 3, computing environment 300 includes one or more remote computing devices 302, one or more servers 304, an agent/host computing device 308, a device controller 310, and a controllable device 312. Remote computing device(s) 302 includes a touchless device manager 314. Server(s) 304 includes a touchless device manager 316, device A-N firmware 318, device A-N software 320, and one or more device A-N control scripts 322. Agent/host computing device 308 includes a touchless device manager 324. Device controller 310 includes a USB-A connector 374A, a USB-C connector 374B, a USB-C connector 374C, a USB switch 373, a translator/bridge 361, a bridge configurer 363, a microcontroller 365, a level shifter 367, one or more multiplexers 369, a USB switch 371, a level shifter 373, a connector 376, a level shifter 379, and a level shifter 381, and has an associated an external device 372. These components of environment 300 are described in further detail as follows.

As shown in FIG. 3, remote computing device(s) 302, server(s) 304, and agent/host computing device 308 are communicatively coupled by network(s) 306 in support of remote control of controllable device 312. Agent/host computing device 308 is coupled to device controller 310. In examples, agent/host computing device 308 and remote computing devices 302 may run, for example, remote desktop in a Microsoft Windows® operating system to allow remote computing devices 302 to remote into agent/host computing device 308. In an example, there may be multiple controllable devices 312. Each controllable device 312 that can be accessed by a remote computing device 302 can have a different network path. Different permutations/combinations of firmware and software (e.g., OS, drivers, applications) can be remote-control flashed onto the multiple controllable devices 312 to perform testing. In one example, under the remote control of a remote computing device 302, controllable device 312 can be caused to flash new firmware on controllable device 312 from external device 372. By remote computing device 302 controlling such firmware flashing, the OS of controllable device 312 is not needed for such flashing, thereby avoiding the need for local manual interaction while increasing productivity and reducing costs associated with device production, travel, and shipping.

Touchless device manager and/or control scripts 322 may be executed by remote computing device(s) 302 (e.g., touchless device manager 314), server(s) 304 (e.g., touchless device manager 316), and/or agent/host computing device 308 (e.g., touchless device manager 324) to remotely configure and/or operate controllable device 212 for any purpose (e.g., for demonstration, testing, debugging, and so on).

Agent/host computing device(s) 308 can communicate with remote computing device(s) 302 and/or server(s) 304 through network(s) 306, for example, to provide and/or receive information in support of remote monitoring and control of controllable device 312. For example, agent/host computing device 308 may receive instructions to configure and/or operate device controller 310 and/or controllable device 312, monitor and/or control signals in device controller 310 and/or controllable device 312, etc. In some examples, a state machine controls the state of device controller 310 as a result of processing touchless device manager and/or one or more scripts 322 associated with control of controllable device 312. Device A-N firmware (F/W) and device A-N software 320 may be selected and used, e.g., during execution of touchless device manager and/or scripts 322, to modify the firmware and/or software of controllable device 312.

External device 372 can be any device that could be communicatively coupled to controllable device 312, such as any type of device that could be inserted into USB-A connector 374A (e.g., or other type of connector implemented in other examples). Examples of external device(s) 372 include, for example, removable external user interface devices (e.g., touchpads, keyboards, touch screens, pointing devices, storage devices, display screens, game controllers, speakers), portable storage devices, cameras, and so on. External device(s) 372 can be collocated (e.g., and locally connected) with device controller 372 or remote (e.g., by wired or wireless connection). In some examples, external device 372 may be a USB key, which could be a flash memory based USB drive, a security device used to identify and/or authenticate a user, a transceiver for wireless communication with wireless devices, etc.

USB-A connector 374A is an example of a communication interface connector that may be used to emulate connection of external devices to controllable device 312 (e.g., is an example of external device emulator external device emulator 264). External device 372 may have a USB-A type connector or may have an adapter for insertion into USB-A connector 374A. USB-A connector 374A is coupled to USB switch 373 for selective connection to USB-A connector 374A and any external device 372.

USB-C connector 374B is an example of a communication interface connector that may be the same as or adaptable to a communication interface connector associated with controllable device 312. For example, a USB-C cable may connect device controller 310 at USB-C connector 374B to a USB-C connector associated with controllable device 312. USB-C connector 374B is coupled to USB switch 373 for selective connection to USB-C connector 374B and controllable device 312.

USB-C connector 374C is an example of a communication interface connector that may be the same as or adaptable to a communication interface connector associated with agent/host computing device 308, and is an example of remote control interface 260. For example, a USB-C cable may connect device controller 310 at USB-C connector 374C to a USB-C connector associated with agent/host computing device 308. USB-C connector 374C is coupled to USB switch 373 for selective connection to USB-C connector 374C and agent/host computing device 308. USB-C connector 374C is coupled to translator/bridge 361, for example, to receive and send signals associated with communication bus signals on controllable device 312 accessible via connector 376.

USB switch 373 provides versatility and minimization of the number of communication connectors used to control controllable device 312, freeing up other connectors, for example, to attach one or more peripherals for expanded operation of controllable device 312. USB switch 373 is controlled to make selective connections, such as one or more of the following: (i) USB-C connector 374C to USB-C connector 374B, which connects agent/host computing device 308 to controllable device 312; (ii) USB-C connector 374C to USB-A connector 374A, which connects agent/host computing device 308 to external device 372 (e.g., USB key); (iii) USB-A connector 374A to USB-C connector 374B, which connects external device 372 to controllable device 312; (iv) USB-C 374C to microcontroller 365, which connects agent/host computing device 308 to microcontroller 365; (v) microcontroller 365 to USB-C connector 374B, which connects microcontroller 365 to controllable device 312; (vi) microcontroller 365 to USB-A connector 374A, which connects microcontroller 365 to external device 372.

USB-C connector 374C receives and transmits signals for remote monitoring and control of controllable device 312. The signals can be, for example, data and control signals provided to and/or received for user input emulation, external device emulation, and/or communication bus emulation. Control signals provided through USB-C connector 374C to microcontroller 365 may support, for example, emulation of user input through a first set of input devices (e.g., external input device(s)) of controllable device 312 (e.g., is an example of user input emulator 262). Control signals provided through USB-C connector 374C to translator/bridge 361 (e.g., through USB switch 373) may support, for example, emulation of communication buses on controllable device 312, which may include emulation of user input through a second set of input devices (e.g., internal input device(s)) of controllable device 312. Control signals provided through USB-C connector 374C to external device 372 may support, for example, emulation of coupling an external device to a communication interface of controllable device 312. Control signals provided through USB-C connector 374C to controllable device 312 may support, for example, emulation of streaming video to a communication interface of controllable device 312.

For example, external device 372 may be a USB key. Agent/host computing device 308 can write a software image on to the USB key by controlling USB switch 373 to connect USB-C connector 374C to USB-A connector 374A to write the software image to the USB key. Agent/host computing device 308 can control USB switch 373 to connect USB-A connector 374A to USB-C connector 374B and a command to boot controllable device 312 from the USB key (e.g., external device 372) or to flash the image on the USB key to controllable device 312.

Translator/bridge 361 is coupled to agent/host computing device 308 via USB-C connector 374C, to microcontroller 365, and to controllable device 312 via connector 376. Translator/bridge 361 receives and transmits signals (e.g., control signals, data signals) on at least one communication bus in controllable device 312 via the connector 376. Translator/bridge 361 translates signals from one or more bus protocol signals (e.g., USB) to one or more other bus protocol signals (e.g., I2C, SPI, and UART). For example, Translator/bridge 361 may be configured (e.g., by bridge configurer 363) to translate between USB protocol signals received from/provided to agent/host computing device 308 to I2C, SPI, and UART protocols provided to/received from controller device 312 via connector 376. One or more of the transmitted signals can be configured to emulate user input through a second set of input devices associated with controllable device 312 (e.g., internal/integrated HIDs, such as a keyboard, trackpad, touchscreen, power button, etc.). Thus, through the interface of translator/bridge 361, signals of different protocols may be communicated between agent/host computing device 308, microcontroller 365, and controllable device 312, enabling more types of controllable devices 312 and host/agent computing systems 308 to engage in device management operations.

Bridge configurer 363 configures translator/bridge 361 and/or other components, such as level shifters 367, 373, 379, and 381. Bridge configurer 363 may be, for example, an electrically erasable programmable read only memory (EEPROM) configured to store one or more configurations for translator/bridge 361 to operate with one or more controllable devices 312. For example, bridge configurer 363 may configure translator bridge 361 for a first controllable device 312 by configuring channels A, B, C, D, and/or other configurable aspects of translator/bridge 361 for the one or more communication buses on the controllable device (e.g., I2C, SPI, and UART). In an example, bridge configurer 361 configures channel A as SPI, channel B as I2C, and channels C and D as UART.

Microcontroller 365 may be coupled to external device 372, controllable device 312, agent/host computing device 308 based on control of USB switch 373. Microcontroller 365 may also be coupled to translator/bridge 361 through multiplexer(s) 369 and level shifters 373, 367 and/or USB switch 371. Microcontroller may be configured (e.g., by F/W and/or S/W configuration) and/or instructed (e.g., by executable instructions or signaling) to emulate user input operations as if a user was using input devices on controllable device 312. The emulated user operations, e.g., indicated by generated signals, may reach controllable device 312 via USB-C connector 374B and/or via connector 376.

Level shifters 367, 373, 379, and 381 shift voltage levels of signals. Level shifters 367, 373, 379, and 381 are configured (e.g., by bridge configurer 363) based on a mapping of signals on device controller 310, which are mapped to control by touchless device manager and/or scripts, to signals on controllable device 312 and/or based on the type of connection to agent/host computing device 308 (e.g., USB-C connector 374C). In other words, the mapping and paths of various signals on device controllers is configurable for multiple types and/or configurations of controllable devices 312.

Connector 376 is coupled to the channels of translator/bridge 361, e.g., variously through level shifters, switches, MUXs, as per a configuration for a type and/or configuration of controllable device 312. Connector 376 is configured to connect the device controller 310 to one or more connectors on a motherboard of controllable device 312. Connector 376 passes bidirectional traffic to allow remote computing device(s) 302 to monitor and control signals for a wide variety of operations.

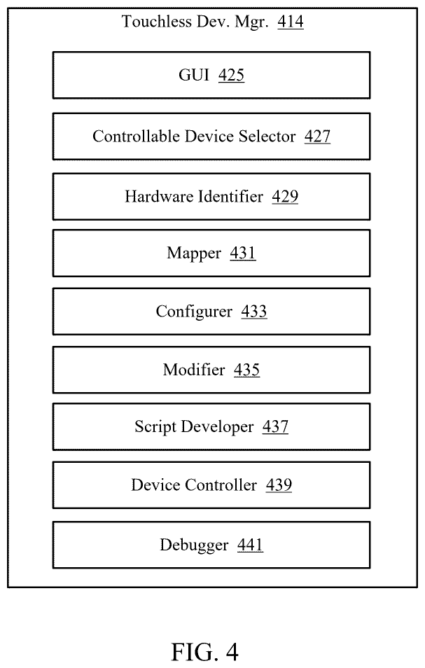

FIG. 4 shows an example touchless device manager 414, according to an embodiment. Touchless device manager 414 is an example of each of touchless device managers 114, 116, 124, 214, 216, and 224 of FIGS. 1 and 2. Accordingly, touchless device manager 414 may be operated on one or more of remote computing devices 102, 202, and 302, one or more of servers 104, 204, and 304, and/or one or more of agent host computing devices 108, 208, and 308. As shown in FIG. 4, touchless device manager 414 includes a GUI 425, a controllable device selector 427, an identifier 429, a mapper 431, a configurer 433, a modifier 435, a script developer 437, a device controller 439, and a debugger 441. Other examples may implement the same or different components. These components of touchless device manager 414 are described in further detail as follows.

GUI 425 is a graphical user interface for users of touchless device manager 414 to navigate and select desired operations, such as displaying and allowing user-selection of device selector 427, software mapper 431, hardware identifier 429, hardware configurer 433, firmware modifier 435, script developer 437, device controller 439, debugger 441, etc.

Controllable device selector 427 is configured to present a user with a scrollable, searchable, selectable list of controllable devices that the user has access to configure and/or to control. For example, the list of controllable devices may include controllable devices in any location (e.g., all over the world) that a user is authorized to access. A user can select a controllable device to proceed with configuration and/or operation of the selected device.

Hardware identifier 429 is configured to search for and present to a user a (e.g., selectable) a device type of the selected controllable device and its configuration, e.g., including a list of devices and components associated with the selected controllable device. The list of devices and components may list a current configuration, for example, including current internal (e.g., integrated) devices and components and current external (e.g., attached) components and devices. Hardware identifier is configured to identify signals of the devices and components that may be monitored or controlled.

In examples, hardware identifier 429 may identify (e.g., on one or more motherboard buses with various protocols, such as SPI, I2C, UART) hardware components, addresses for the components to read and write signals, and signals themselves, such as a volume control signal, a power button signal, various reset signals, among other signals to emulate in order to control the controllable device. Hardware identifier 429 may identify multiple types of reset that are not available to users of the controllable device. Signal monitoring and emulation can be used to provide full hardware control of a controllable device, which may be used to remotely repair bricked (e.g., inoperable) devices using a variety of resets, power control, and flashing firmware and software to recover devices.

Mapper 431 is configured to search for and present to a user a (e.g., selectable) list of firmware and software (e.g., operating system, applications) that is compatible with the selected controllable device, e.g., based on the device type and its configuration (e.g., list of devices and components). For example, mapper 431 can present a user with a list of firmware and software, including source, type, access location, version, release date, download link, and so on.

Configurer 433 is configured to allow a user to select a configuration of firmware (e.g., for each identified device and component) and software (e.g., OS and applications) for the selected controllable device. Configurer 433 is configured to allow a user to select the signals of the devices and components for monitoring and/or control. Configurer 433 is configured to configure the computing device controller to monitor and/or control the selected signals, e.g., to the extent that the computing device controller is configurable automatically by the touchless device manager. Configurer 433 may be aware of the configurability of the computing device controller as well as the hardware configuration of the controllable device. Configurer may generate instructions for any manual configuration of the computing device controller to effectuate the signals selected for monitoring and/or control.

Modifier 435 is configured to implement the selected configuration of firmware and software in the selected controllable device. Modifier may implement the selected firmware and software modification, for example, in accordance with an automated script 122 compatible with the selected controllable device, selected from device A-N control scripts 122A-N/222/322. Modifier 435, alone or with device controller 439, can use emulated signals to update component firmware with or without a functional operating system (e.g., with or without booting the controllable device with the operating system), for example, so that a bricked controllable device (e.g., inoperable controllable device) can be repaired by flashing firmware and/or software to bring a device to a known good state. In some examples, firmware and/or software may be written to external device 172/272/372 for flashing to controllable device.

Script developer 437 is configured to provide a script editor and stored script selector for user to create and select scripts for the controllable device in device A-N control scripts 122A-N/222/322. For example, users can use script developer 437 to create hardware automated test suites to provide ongoing validation of customer experiences. Each script utilizes identified signals for monitoring and/or control operations. Each controllable device can have a pool of automation scripts for various purposes, e.g., operation, demonstration, testing, debugging, and so on.

Device controller 439 is configured to allow a user to exercise remote control over a selected controllable device, for example, with command line instructions and/or with one or more scripts selected (e.g., for application in a defined order) from device A-N control scripts 122A-N/222/322. Device controller 439 may include, for example, a logger configured to display, record and store (e.g., selectable/configurable) results of remote control operation (e.g., testing) of the selected controllable device. During remote control of a selected controllable device, device controller 439 may manage a state machine to manage a state of the selected controllable device. Remote control operation of a selected controllable device may include, for example, applying update to firmware, flashing software (e.g., OS and/or applications), monitoring the stability and recoverability of the controllable device, accessing, managing, controlling, testing, and/or debugging operation of devices and components (e.g., keyboards, buttons, pointing devices, trackpads, cameras, touch screens, batteries, power, charging, audio microphone and speakers, wired and wireless network connectivity, communication interfaces, etc.). During operation (e.g., testing) of the controllable device, GUI 425 may display indications or video of the device controller status indicators and/or video of the display of the controllable device, which may be fed to the agent/host computing device. In some examples, device controller 439 may implement operations of modifier 435.

In an example of operation of a controllable device (e.g., using or testing) operations may be implemented as if a user is physically interacting with the controllable device 312, e.g., performing keyboard or mouse movements to generate USB human interface device (HID) messages to the controllable device 312, as opposed to using unattended files (unattend.xml) to do the operations. A user typing on GUI 425 while using device controller 439 (e.g., in touchless device manager running on remote computing device or agent/host computing device) results in device controller 439 generating control signals that cause the user input emulator 262 (e.g., microcontroller 365) to emulate the HID signals that go to the communication interface (e.g., USB-C 374B) on the controllable device 312 to simulate actual pressing of keys (keystrokes) on a keyboard and/or movement a mouse coupled to controllable device 312 without those events actually occurring.

Debugger 441 is configured to run during operation using device controller 439 to assist with debugging hardware, firmware, and/or software associated with the selected controllable device. Running debugger 441 with device controller 439 can provide user-level debugging control and hardware-level debugging control.

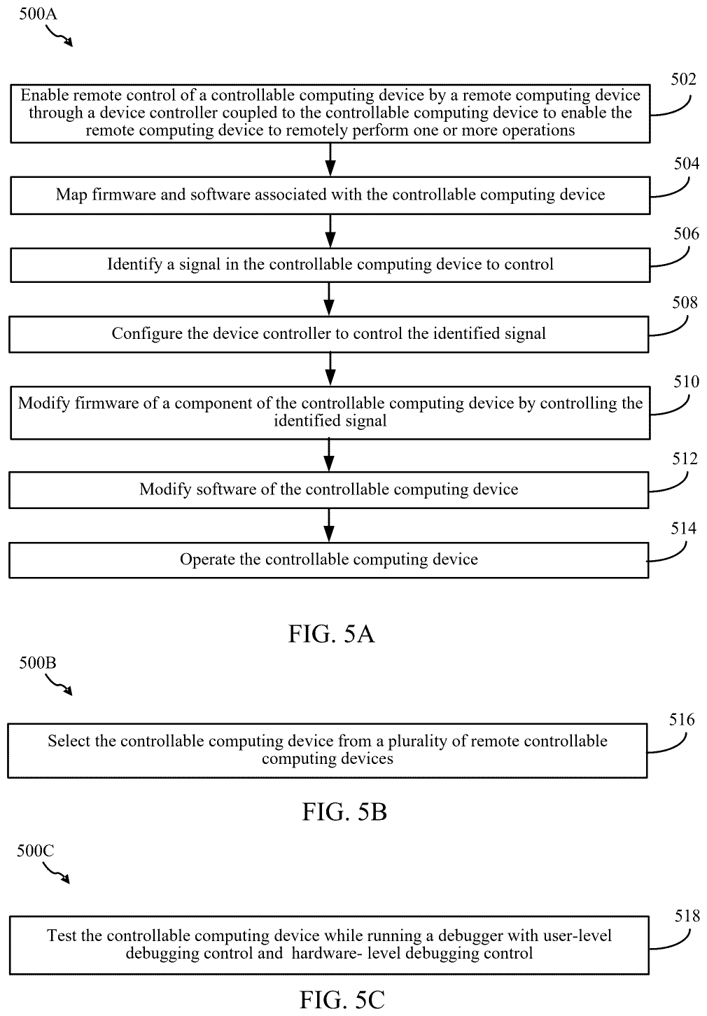

FIGS. 5A-5C show flowcharts 500A-500C for implementing touchless device management, according to example embodiments. Embodiments may operate in accordance with each of flowcharts 500A-500C. Flowchart 500A comprises steps 502-514, flowchart 500B adds step 516, and flowchart 500C adds step 518. However, other embodiments may operate according to other methods. Other structural and operational embodiments will be apparent to persons skilled in the relevant art(s) based on the foregoing discussion of embodiments. There is no requirement that a method embodiment implement all of the steps illustrated in FIGS. 5A-5C. In various implementations, steps may be added, removed, implemented in the alternative, e.g., in any combination or order. FIGS. 5A-5C are simply some of many possible embodiments. Embodiments may implement fewer, more or different steps. Flowcharts 500A-500C are described as follows with respect to FIGS. 1-4.

As shown in FIG. 5A, in step 502, remote control of a controllable device may be enabled for a remote computing device through a device controller coupled to the controllable device to enable the remote computing device to remotely perform one or more operations. For example, as shown in FIGS. 1-4, device controller 110/210/310 coupled to controllable device 112/212/312 is coupled to remote computing device(s) 102/202/302 through agent/host computing device 108/208/308 and network(s) 106/206/306, enabling remote control of controllable device 112/212/312 by remote computing device(s) 102/202/302 execution of touchless device manager 114/214/314/414, control script(s) 122, and/or command line instructions.

In step 504, a remote operation may be performed to map firmware and software associated with the controllable device. For example, as shown in FIGS. 1-4, remote computing device(s) 102/202/302 executing touchless device manager 114/214/314/414 can use mapper 431 to map software and firmware in device A-N firmware 118A-118N and device A-N software 120A-120N associated with controllable device 112/212/312.

In step 506, a remote operation may be performed to identify a signal in the controllable device to control. For example, as shown in FIGS. 1-4, remote computing device(s) 102/202/302 executing touchless device manager 114/214/314/414 can use hardware identifier 429 to identify one or more signals in controllable device 112/212/312 to control.

In step 508, a remote operation may be performed to configure the device controller to control the identified signal. For example, as shown in FIGS. 1-4, remote computing device(s) 102/202/302 executing touchless device manager 114/214/314/414 can use configurer 433 to configure device controller 110/210/310 to control the identified signal in controllable device 112/212/312. Such remote mapping (of step 504) and performance of remote operation (of step 508) enables the remote determination and reconfiguration of firmware and software (e.g., operating system, applications) compatible with the selected controllable device from any location, increasing productivity with 24 hours of access around the world and reducing costs associated with device production, travel, and shipping.

In step 510, a remote operation may be performed to modify firmware of a component of the controllable device by controlling the identified signal. For example, as shown in FIGS. 1-4, remote computing device(s) 102/202/302 executing touchless device manager 114/214/314/414 can use modifier 435 and/or device controller 439 to modify firmware of a component in controllable device 112/212/312 by controlling the identified signal.

In step 512, a remote operation may be performed to modify software of the controllable device. For example, as shown in FIGS. 1-4, remote computing device(s) 102/202/302 executing touchless device manager 114/214/314/414 can use modifier 435 and/or device controller 439 to modify software of controllable device 112/212/312.

In step 514, a remote operation may be performed to operate the controllable device. For example, as shown in FIGS. 1-4, remote computing device(s) 102/202/302 executing touchless device manager 114/214/314/414 can use device controller 439 to operate controllable device 112/212/312.

As shown in FIG. 5B, in step 516, a remote operation may be performed to select the controllable device from a plurality of remote controllable devices. For example, as shown in FIGS. 1-4, remote computing device(s) 102/202/302 executing touchless device manager 114/214/314/414 can use controllable device selector 427 to select controllable device 112/212/312 from a plurality of remote controllable devices.

As shown in FIG. 5C, in step 518, a remote operation may be performed to test the controllable device while running a debugger with user-level debugging control and hardware-level debugging control. For example, as shown in FIGS. 1-4, remote computing device(s) 102/202/302 executing touchless device manager 114/214/314/414 can use device controller 439 to test controllable device 112/212/312 (e.g., perform operations and monitor/log results) while also using/running debugger 441 with user-level debugging control and hardware-level debugging control.

Other steps may include, for example, connecting a device controller to a controllable device and an agent/host computing device executing a version (e.g., an agent version) of touchless device manager to make controllable device network accessible to remote computing devices and servers executing versions of touchless device manager in order to manage a number of controllable devices in a number of locations.

Users of remote computing device may perform logins and go through an authorization process so that touchless device manager can determine and present (e.g., in GUI 425) only the set of remote controllable devices, and or level of device control, that each user is authorized for. For example, user A may be given unlimited access to a controllable device while user B may be allowed restricted/limited access to the controllable device, such as access to test results, but not operational access, or access to a subset of signals less than all signals.

### III. Example Computing Device Embodiments

Touchless device managers 114, 116, 124, 214, 216, 224, 314, 316, 324, 414, device A-N control scripts 122A-122N, 222, 322, user input emulator 262, external device emulator 264, communication bus emulator 266, internal device emulator 268, GUI 425, controllable device selector 427, identifier 429, mapper 431, configurer 433, modifier 435, script developer 437, device controller 439, and debugger 441, and flowcharts 500A, 500B, and 500C are each implementable as computer program code/instructions configured to be executed in one or more processors and stored in a computer readable storage medium. Alternatively, touchless device managers 114, 116, 124, 214, 216, 224, 314, 316, 324, 414, device A-N control scripts 122A-122N, 222, 322, user input emulator 262, external device emulator 264, communication bus emulator 266, internal device emulator 268, GUI 425, controllable device selector 427, identifier 429, mapper 431, configurer 433, modifier 435, script developer 437, device controller 439, and debugger 441, and flowcharts 500A, 500B, and 500C are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 6. FIG. 6 shows a block diagram of an exemplary computing environment 600 that includes a computing device 602. Computing device 602 is an example of each of computing devices 102A-102N, server(s) 104, controllable device 112, remote computing device(s) 202, server(s) 204, agent/host computing device 208, controllable device 212, remote computing device(s) 302, server(s) 304, and controllable device 312, which may each include one or more of the components of computing device 602. In some embodiments, computing device 602 is communicatively coupled with devices (not shown in FIG. 6) external to computing environment 600 via network 604. Network 604 comprises one or more networks such as local area networks (LANs), wide area networks (WANs), enterprise networks, the Internet, etc. In examples, network 604 includes one or more wired and/or wireless portions. In some examples, network 604 additionally or alternatively includes a cellular network for cellular communications. Computing device 602 is described in detail as follows.

Computing device 602 is any of a variety of types of computing devices. Examples of computing device 602 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 602 is a stationary computing device such as a desktop computer, a personal computer (PC), a stationary server device, a minicomputer, a mainframe, a supercomputer, etc.

As shown in FIG. 6, computing device 602 includes a variety of hardware and software components, including a processor 610, a storage 620, a graphics processing unit (GPU) 642, a neural processing unit (NPU) 644, one or more input devices 630, one or more output devices 650, one or more wireless modems 660, one or more wired interfaces 680, a power supply 682, a location information (LI) receiver 684, and an accelerometer 686. Storage 620 includes memory 656, which includes non-removable memory 622 and removable memory 624, and a storage device 688. Storage 620 also stores an operating system 612, application programs 614, and application data 616. Wireless modem(s) 660 include a Wi-Fi modem 662, a Bluetooth modem 664, and a cellular modem 666. Output device(s) 650 includes a speaker 652 and a display 654. Input device(s) 630 includes a touch screen 632, a microphone 634, a camera 636, a physical keyboard 638, and a trackball 640. Not all components of computing device 602 shown in FIG. 6 are present in all embodiments, additional components not shown may be present, and in a particular embodiment any combination of the components are present. In examples, components of computing device 602 are mounted to a circuit card (e.g., a motherboard) of computing device 602, integrated in a housing of computing device 602, or otherwise included in computing device 602. The components of computing device 602 are described as follows.

In embodiments, a single processor 610 (e.g., central processing unit (CPU), microcontroller, a microprocessor, signal processor, ASIC (application specific integrated circuit), and/or other physical hardware processor circuit) or multiple processors 610 are present in computing device 602 for performing such tasks as program execution, signal coding, data processing, input/output processing, power control, and/or other functions. In examples, processor 610 is a single-core or multi-core processor, and each processor core is single-threaded or multithreaded (to provide multiple threads of execution concurrently). Processor 610 is configured to execute program code stored in a computer readable medium, such as program code of operating system 612 and application programs 614 stored in storage 620. The program code is structured to cause processor 610 to perform operations, including the processes/methods disclosed herein. Operating system 612 controls the allocation and usage of the components of computing device 602 and provides support for one or more application programs 614 (also referred to as “applications” or “apps”). In examples, application programs 614 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 610 includes one or more general processors (e.g., CPUs) configured with or coupled to one or more hardware accelerators, such as one or more NPUs 644 and/or one or more GPUs 642.

Any component in computing device 602 can communicate with any other component according to function, although not all connections are shown for ease of illustration. For instance, as shown in FIG. 6, bus 606 is a multiple signal line communication medium (e.g., conductive traces in silicon, metal traces along a motherboard, wires, etc.) present to communicatively couple processor 610 to various other components of computing device 602, although in other embodiments, an alternative bus, further buses, and/or one or more individual signal lines is/are present to communicatively couple components. Bus 606 represents one or more of any of several types of bus structures, including a memory bus or memory controller, a peripheral bus, an accelerated graphics port, and a processor or local bus using any of a variety of bus architectures.

Storage 620 is physical storage that includes one or both of memory 656 and storage device 688, which store operating system 612, application programs 614, and application data 616 according to any distribution. Non-removable memory 622 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 622 includes main memory and is separate from or fabricated in a same integrated circuit as processor 610. As shown in FIG. 6, non-removable memory 622 stores firmware 618 that is present to provide low-level control of hardware. Examples of firmware 618 include BIOS (Basic Input/Output System, such as on personal computers) and boot firmware (e.g., on smart phones). In examples, removable memory 624 is inserted into a receptacle of or is otherwise coupled to computing device 602 and can be removed by a user from computing device 602. Removable memory 624 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 688 are present that are internal and/or external to a housing of computing device 602 and are or are not removable. Examples of storage device 688 include a hard disk drive, a SSD, a thumb drive (e.g., a USB (Universal Serial Bus) flash drive), or other physical storage device.

One or more programs are stored in storage 620. Such programs include operating system 612, one or more application programs 614, and other program modules and program data. Examples of such application programs include computer program logic (e.g., computer program code/instructions) for implementing touchless device managers 114, 116, 124, 214, 216, 224, 314, 316, 324, 414, device A-N control scripts 122A-122N, 222, 322, user input emulator 262, external device emulator 264, communication bus emulator 266, internal device emulator 268, GUI 425, controllable device selector 427, identifier 429, mapper 431, configurer 433, modifier 435, script developer 437, device controller 439, and debugger 441, and flowcharts 500A, 500B, and 500C (and/or any individual steps thereof).

Storage 620 also stores data used and/or generated by operating system 612 and application programs 614 as application data 616. Examples of application data 616 include web pages, text, images, tables, sound files, video data, and other data. In examples, application data 616 is sent to and/or received from one or more network servers or other devices via one or more wired or wireless networks. Storage 620 is used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 602 through one or more input devices 630 and receives information from computing device 602 through one or more output devices 650. Input device(s) 630 includes one or more of touch screen 632, microphone 634, camera 636, physical keyboard 638 and/or trackball 640 and output device(s) 650 includes one or more of speaker 652 and display 654. Each of input device(s) 630 and output device(s) 650 are integral to computing device 602 (e.g., built into a housing of computing device 602) or are external to computing device 602 (e.g., communicatively coupled wired or wirelessly to computing device 602 via wired interface(s) 680 and/or wireless modem(s) 660). Further input devices 630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 654 displays information, as well as operating as touch screen 632 by receiving user commands and/or other information (e.g., by touch, finger gestures, virtual keyboard, etc.) as a user interface. Any number of each type of input device(s) 630 and output device(s) 650 are present, including multiple microphones 634, multiple cameras 636, multiple speakers 652, and/or multiple displays 654.

In embodiments where GPU 642 is present, GPU 642 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 642 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 644 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 628. In an example, NPU 644 is configured for a data-driven parallel computing and is highly efficient at processing massive multimedia data such as videos and images and processing data for neural networks. NPU 644 is configured for efficient handling of AI-related tasks, such as speech recognition, background blurring in video calls, photo or video editing processes like object detection, etc.

In embodiments disclosed herein that implement ML models, NPU 644 can be utilized to execute such ML models, of which MLM 628 is an example. For instance, where applicable, MLM 628 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 644 is used to train MLM 628. To train MLM 628, training data is that includes input features (attributes) and their corresponding output labels/target values (e.g., for supervised learning) is collected. A training algorithm is a computational procedure that is used so that MLM 628 learns from the training data. Examples of training inputs for ML model training include user position, angle, gesture, time of day, location, user crypto, etc. Parameters/weights are internal settings of MLM 628 that are adjusted during training by the training algorithm to reduce a difference between predictions by MLM 628 and actual outcomes (e.g., output labels). In some examples, MLM 628 is set with initial values for the parameters/weights. A loss function measures a dissimilarity between predictions by MLM 628 and the target values, and the parameters/weights of MLM 628 are adjusted to minimize the loss function. The parameters/weights are iteratively adjusted by an optimization technique, such as gradient descent. In this manner, MLM 628 is generated through training by NPU 644 to be used to generate inferences based on received input feature sets for particular applications. MLM 628 is generated as a computer program or other type of algorithm configured to generate an output (e.g., a classification, a prediction/inference) based on received input features and is stored in the form of a file or other data structure.

In examples, such training of MLM 628 by NPU 644 is supervised or unsupervised. According to supervised learning, input objects (e.g., a vector of predictor variables) and a desired output value (e.g., a human-labeled supervisory signal) train MLM 628. The training data is processed, building a function that maps new data on expected output values. Example algorithms usable by NPU 644 to perform supervised training of MLM 628 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 628 is an LLM, MLM 628 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 628 is trained to learn patterns from unlabeled data. For instance, in embodiments where MLM 628 implements unsupervised learning techniques, MLM 628 identifies one or more classifications or clusters to which an input belongs. During a training phase of MLM 628 according to unsupervised learning, MLM 628 tries to mimic the provided training data and uses the error in its mimicked output to correct itself (i.e., correct weights and biases). In further examples, NPU 644 perform unsupervised training of MLM 628 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 644 need not necessarily be present in all ML model embodiments. In embodiments where ML models are present, any one or more of processor 610, GPU 642, and/or NPU 644 can be present to train and/or execute MLM 628.

One or more wireless modems 660 can be coupled to antenna(s) (not shown) of computing device 602 and can support two-way communications between processor 610 and devices external to computing device 602 through network 604, as would be understood to persons skilled in the relevant art(s). Wireless modem 660 is shown generically and can include a cellular modem 666 for communicating with one or more cellular networks, such as a GSM network for data and voice communications within a single cellular network, between cellular networks, or between the mobile device and a public switched telephone network (PSTN). In examples, wireless modem 660 also or alternatively includes other radio-based modem types, such as a Bluetooth modem 664 (also referred to as a “Bluetooth device”) and/or Wi-Fi modem 662 (also referred to as an “wireless adaptor”). Wi-Fi modem 662 is configured to communicate with an access point or other remote Wi-Fi-capable device according to one or more of the wireless network protocols based on the IEEE (Institute of Electrical and Electronics Engineers) 602.11 family of standards, commonly used for local area networking of devices and Internet access. Bluetooth modem 664 is configured to communicate with another Bluetooth-capable device according to the Bluetooth short-range wireless technology standard(s) such as IEEE 602.15.1 and/or managed by the Bluetooth Special Interest Group (SIG).

Computing device 602 can further include power supply 682, LI receiver 684, accelerometer 686, and/or one or more wired interfaces 680. Example wired interfaces 680 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 680 of computing device 602 provide for wired connections between computing device 602 and network 604, or between computing device 602 and one or more devices/peripherals when such devices/peripherals are external to computing device 602 (e.g., a pointing device, display 654, speaker 652, camera 636, physical keyboard 638, etc.). Power supply 682 is configured to supply power to each of the components of computing device 602 and receives power from a battery internal to computing device 602, and/or from a power cord plugged into a power port of computing device 602 (e.g., a USB port, an A/C power port). LI receiver 684 is useable for location determination of computing device 602 and in examples includes a satellite navigation receiver such as a Global Positioning System (GPS) receiver and/or includes other type of location determiner configured to determine location of computing device 602 based on received information (e.g., using cell tower triangulation, etc.). Accelerometer 686, when present, is configured to determine an orientation of computing device 602.

Note that the illustrated components of computing device 602 are not required or all-inclusive, and fewer or greater numbers of components can be present as would be recognized by one skilled in the art. In examples, computing device 602 includes one or more of a gyroscope, barometer, proximity sensor, ambient light sensor, digital compass, etc. In an example, processor 610 and memory 656 are co-located in a same semiconductor device package, such as being included together in an integrated circuit chip, FPGA, or system-on-chip (SOC), optionally along with further components of computing device 602.

In embodiments, computing device 602 is configured to implement any of the above-described features of flowcharts herein. Computer program logic for performing any of the operations, steps, and/or functions described herein is stored in storage 620 and executed by processor 610.

In some embodiments, server infrastructure 670 is present in computing environment 600 and is communicatively coupled with computing device 602 via network 604. Server infrastructure 670, when present, is a network-accessible server set (e.g., a cloud-based environment or platform). As shown in FIG. 6, server infrastructure 670 includes clusters 672. Each of clusters 672 comprises a group of one or more compute nodes and/or a group of one or more storage nodes. For example, as shown in FIG. 6, cluster 672 includes nodes 674. Each of nodes 674 are accessible via network 604 (e.g., in a “cloud-based” embodiment) to build, deploy, and manage applications and services. In examples, any of nodes 674 is a storage node that comprises a plurality of physical storage disks, SSDs, and/or other physical storage devices that are accessible via network 604 and are configured to store data associated with the applications and services managed by nodes 674.

Each of nodes 674, as a compute node, comprises one or more server computers, server systems, and/or computing devices. For instance, a node 674 in accordance with an embodiment includes one or more of the components of computing device 602 disclosed herein. Each of nodes 674 is configured to execute one or more software applications (or “applications”) and/or services and/or manage hardware resources (e.g., processors, memory, etc.), which are utilized by users (e.g., customers) of the network-accessible server set. In examples, as shown in FIG. 6, nodes 674 includes a node 646 that includes storage 648 and/or one or more of a processor 658 (e.g., similar to processor 610, GPU 642, and/or NPU 644 of computing device 602). Storage 648 stores application programs 676 and application data 678. Processor(s) 658 operate application programs 676 which access and/or generate related application data 678. In an implementation, nodes such as node 646 of nodes 674 operate or comprise one or more virtual machines, with each virtual machine emulating a system architecture (e.g., an operating system), in an isolated manner, upon which applications such as application programs 676 are executed.

In embodiments, one or more of clusters 672 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 672 are included in a datacenter in a distributed collection of datacenters. In embodiments, exemplary computing environment 600 comprises part of a cloud-based platform.

In an embodiment, computing device 602 accesses application programs 676 for execution in any manner, such as by a client application and/or a browser at computing device 602.

In an example, for purposes of network (e.g., cloud) backup and data security, computing device 602 additionally and/or alternatively synchronizes copies of application programs 614 and/or application data 616 to be stored at network-based server infrastructure 670 as application programs 676 and/or application data 678. In examples, operating system 612 and/or application programs 614 include a file hosting service client configured to synchronize applications and/or data stored in storage 620 at network-based server infrastructure 670.

In some embodiments, on-premises servers 692 are present in computing environment 600 and are communicatively coupled with computing device 602 via network 604. On-premises servers 692, when present, are hosted within an organization's infrastructure and, in many cases, physically onsite of a facility of that organization. On-premises servers 692 are controlled, administered, and maintained by IT (Information Technology) personnel of the organization or an IT partner to the organization. Application data 698 can be shared by on-premises servers 692 between computing devices of the organization, including computing device 602 (when part of an organization) through a local network of the organization, and/or through further networks accessible to the organization (including the Internet). Furthermore, in examples, on-premises servers 692 serve applications such as application programs 696 to the computing devices of the organization, including computing device 602. Accordingly, in examples, on-premises servers 692 include storage 694 (which includes one or more physical storage devices such as storage disks and/or SSDs) for storage of application programs 696 and application data 698 and include a processor 690 (e.g., similar to processor 610, GPU 642, and/or NPU 644 of computing device 602) for execution of application programs 696. In some embodiments, multiple processors 690 are present for execution of application programs 696 and/or for other purposes. In further examples, computing device 602 is configured to synchronize copies of application programs 614 and/or application data 616 for backup storage at on-premises servers 692 as application programs 696 and/or application data 698.

Embodiments described herein may be implemented in one or more of computing device 602, network-based server infrastructure 670, and on-premises servers 692. For example, in some embodiments, computing device 602 is used to implement systems, clients, or devices, or components/subcomponents thereof, disclosed elsewhere herein. In other embodiments, a combination of computing device 602, network-based server infrastructure 670, and/or on-premises servers 692 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 620. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 614) are stored in storage 620. Such computer programs can also be received via wired interface(s) 660 and/or wireless modem(s) 660 over network 604. Such computer programs, when executed or loaded by an application, enable computing device 602 to implement features of embodiments discussed herein. Accordingly, such computer programs represent controllers of the computing device 602.

Embodiments are also directed to computer program products comprising computer code or instructions stored on any computer-readable medium or computer-readable storage medium. Such computer program products include the physical storage of storage 620 as well as further physical storage types.

### IV. Further Example Embodiments

Methods, systems, and computer program products are provided for touchless device management. A device can be operated remotely from any location for any purpose, including demonstration, teaching, product development, testing, debugging, and repairing, thereby reducing costs associated with device production, travel, and shipping. Configuration for remote control includes configuring the controller to control hardware signals of the controllable device (e.g., by mapping connector pins, configuring signal translation (e.g., from universal serial bus (USB) to Universal Asynchronous Receiver Transmitter (UART), serial peripheral interface (SPI), inter-integrated circuit (I2C) signals) and voltage level shifting of signals. Firmware and software can be mapped for a variety of controllable devices. The controller includes network access or is attached to a local host/agent computing device with network access for remote control. A remote host can modify firmware, update software, power up, power down, boot, and operate the controllable device (e.g., with command line instructions and/or automated scripts), run a debugger during operation, etc. Remote operation includes generating signaling that simulates a user operating internal and external input devices of the controllable device. The remote host can display video of the controllable device and device controller provided by a camera coupled to the local host/agent device, providing complete interaction.

In one aspect, a computing device controller comprises: a connector configured to connect the computing device controller to a controllable device; a user input emulator configured to generate signals to emulate user input through a first set of (e.g., external) human interface devices (HIDs) associated with the controllable device; a communication bus emulator configured to receive and transmit signals (e.g., control signals, data signals) on at least one communication bus in the controllable device via the connector, at least one of the transmitted signals emulating user input through a second set of (e.g., internal) HIDs associated with the controllable device; an external device emulator configured to emulate connection of an external device (e.g., USB key) to a communication interface of the controllable device; and a remote control interface configured to receive and transmit signals for remote monitoring and control of the controllable device, the signals comprising control signals provided to the user input emulator and the communication bus emulator for the emulation of the user input through the first and second HIDs.

In examples, the first set of HIDs comprises at least one HID communicatively coupled to an external communication interface of the controllable device and the second set of HIDs comprises at least one HID integrated in the controllable device.

In examples, the remote control interface is configured to connect the computing device controller to a host computing device configured to execute instructions that generate the control signals received by the remote control interface.

In examples, the communication bus emulator comprises a translator or bridge configured to translate signals between the host computing device and the at least one communication bus in the controllable device.

In examples, the computing device further comprises a switch configured to selectively connect the host computing device to at least one of the external device emulator or the user input emulator.

In examples, the host computing device generates control signals that cause the controllable device to boot from an operating system on the external device emulated by the external device emulator.

In examples, the remote control interface comprises a network transceiver configured to connect to a remote computing device through a communication network.

In another aspect, a method comprises enabling remote control of a controllable device by a remote computing device through a device controller coupled to the controllable device to enable the remote computing device to remotely perform: mapping firmware and software associated with the controllable device; identifying a signal in the controllable device to control; configuring the device controller to control the identified signal; modifying firmware of a component of the controllable device by controlling the identified signal; modifying software of the controllable device; and operating the controllable device.

In examples, the operating of the controllable device comprises emulating disconnection of a battery of the controllable device and reconnection of the battery; or emulating disconnection of an alternating current (AC) power source of the controllable device and reapplying the AC power source; and booting the controllable device after the reconnection of the battery or the reapplying of the AC power source. In this manner, full power down and then power up of the controllable device may be emulated, such as to place the controllable device in a newly powered state or to simulate an unexpected power loss, which enables various device management (e.g., rebooting) and/or debugging operations without manual interaction.

In examples, the operating of the controllable device comprises operating or testing the controllable device using a script that automatically controls operation of the controllable device.

In examples, the modifying of the software of the controllable device comprises flashing an image of an operating system on the controllable device from a memory device coupled to the device controller.

In examples, the modifying firmware of a component of the controllable device by controlling the identified signal comprises: flashing the firmware on the component without using an operating system of the controllable device.

In examples, the remote computing device is further enabled to remotely perform selecting the controllable device from a plurality of remote controllable devices.

In examples, the remote computing device is further enabled to remotely perform testing the controllable device while running a debugger with user-level debugging control and hardware-level debugging control.

In examples, the operating of the controllable device comprises controlling a user input emulator in the device controller to generate signals to emulate user input through a first set of human interface devices (HIDs) associated with the controllable device.

In examples, the operating of the controllable device comprises controlling a communication bus emulator in the device controller to receive and transmit signals on at least one communication bus in the controllable device, at least one of the transmitted signals emulating user input through a second set of HIDs associated with the controllable device.

In examples, the operating of the controllable device comprises controlling an external device emulator in the device controller to emulate connection of an external device to a communication interface of the controllable device.

In another aspect, a computer-readable storage medium may have program instructions recorded thereon that, when executed by a processing circuit, perform a method. The method may comprise enabling remote control of a controllable device by a remote computing device through a device controller coupled to the controllable device to enable the remote computing device to remotely perform selecting the controllable device from a plurality of remote controllable devices; mapping firmware and software associated with the controllable device; identifying a signal in the controllable device to control; configuring the device controller to control the identified signal; modifying firmware of a component of the controllable device by controlling the identified signal; and operating the controllable device.

In examples, the remote computing device is further enabled to remotely perform testing the controllable device while running a debugger with user-level debugging control and hardware-level debugging control.

In examples, the operating of the controllable device comprises controlling an external device emulator in the device controller to emulate connection of an external device to a communication interface of the controllable device; and controlling the external device emulator to flash software on to the controllable device from a storage device coupled to the device controller.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

If the performance of an operation is described herein as being “based on” one or more factors, it is to be understood that the performance of the operation may be based solely on such factor(s) or may be based on such factor(s) along with one or more additional factors. Thus, as used herein, the term “based on” should be understood to be equivalent to the term “based at least on.”

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A computing device controller comprising:
a connector configured to connect the computing device controller to a controllable device;
a user input emulator configured to generate signals to emulate user input through a first set of human interface devices (HIDs) associated with the controllable device;
a communication bus emulator configured to receive and transmit signals on at least one communication bus in the controllable device via the connector, at least one of the transmitted signals emulating user input through a second set of HIDs associated with the controllable device;
an external device emulator configured to emulate connection of an external device to a communication interface of the controllable device; and
a remote control interface configured to receive and transmit signals for remote monitoring and control of the controllable device, the signals comprising control signals provided to the user input emulator and the communication bus emulator for the emulation of the user input through the first and second HIDs.

2. The computing device controller of claim 1,
wherein the first set of HIDs comprises at least one HID communicatively coupled to an external communication interface of the controllable device; and
wherein the second set of HIDs comprises at least one HID integrated in the controllable device.

3. The computing device controller of claim 1, wherein the remote control interface is configured to connect the computing device controller to a host computing device configured to execute instructions that generate the control signals received by the remote control interface.

4. The computing device controller of claim 3, wherein the communication bus emulator comprises a translator or bridge configured to translate signals between the host computing device and the at least one communication bus in the controllable device.

5. The computing device controller of claim 3, further comprising:
a switch configured to selectively connect the host computing device to at least one of the external device emulator or the user input emulator.

6. The computing device controller of claim 3, wherein the host computing device generates control signals that cause the controllable device to boot from an operating system on the external device emulated by the external device emulator.

7. The computing device controller of claim 1, wherein the remote control interface comprises a network transceiver configured to connect to a remote computing device through a communication network.

8. A computer-implemented method comprising:
enabling remote control of a controllable device by a remote computing device through a device controller coupled to the controllable device to enable the remote computing device to remotely perform:
mapping firmware and software associated with the controllable device;
identifying a signal in the controllable device to control;
configuring the device controller to control the identified signal;
modifying firmware of a component of the controllable device by controlling the identified signal;
modifying software of the controllable device; and
operating the controllable device.

9. The computer-implemented method of claim 8, wherein the operating of the controllable device comprises:
emulating disconnection of a battery of the controllable device and reconnection of the battery; or
emulating disconnection of an alternating current (AC) power source of the controllable device and reapplying the AC power source; and
booting the controllable device after the reconnection of the battery or the reapplying of the AC power source.

10. The computer-implemented method of claim 8, wherein the operating of the controllable device comprises:
operating or testing the controllable device using a script that automatically controls operation of the controllable device.

11. The computer-implemented method of claim 8, wherein the modifying of the software of the controllable device comprises flashing an image of an operating system on the controllable device from a memory device coupled to the device controller.

12. The computer-implemented method of claim 8, wherein the modifying firmware of a component of the controllable device by controlling the identified signal comprises:
flashing the firmware on the component without using an operating system of the controllable device.

13. The computer-implemented method of claim 8, further enabling the remote computing device to remotely perform:
selecting the controllable device from a plurality of remote controllable devices.

14. The computer-implemented method of claim 8, further enabling the remote computing device to remotely perform:
testing the controllable device while running a debugger with user-level debugging control and hardware-level debugging control.

15. The computer-implemented method of claim 8, wherein the operating of the controllable device comprises:
controlling a user input emulator in the device controller to generate signals to emulate user input through a first set of human interface devices (HIDs) associated with the controllable device.

16. The computer-implemented method of claim 15, wherein the operating of the controllable device comprises:
controlling a communication bus emulator in the device controller to receive and transmit signals on at least one communication bus in the controllable device, at least one of the transmitted signals emulating user input through a second set of HIDs associated with the controllable device.

17. The computer-implemented method of claim 8, wherein the operating of the controllable device comprises:
controlling an external device emulator in the device controller to emulate connection of an external device to a communication interface of the controllable device.

18. A computer-readable storage medium having program instructions recorded thereon that, when executed by a processing circuit, perform a method comprising:
enabling remote control of a controllable device by a remote computing device through a device controller coupled to the controllable device to enable the remote computing device to remotely perform:
selecting the controllable device from a plurality of remote controllable devices;
mapping firmware and software associated with the controllable device;
identifying a signal in the controllable device to control;
configuring the device controller to control the identified signal;
modifying firmware of a component of the controllable device by controlling the identified signal; and
operating the controllable device.

19. The computer-readable storage medium of claim 18, further enabling the remote computing device to remotely perform:
testing the controllable device while running a debugger with user-level debugging control and hardware-level debugging control.

20. The computer-implemented method of claim 18, wherein the operating of the controllable device comprises:
controlling an external device emulator in the device controller to emulate connection of an external device to a communication interface of the controllable device; and
controlling the external device emulator to flash software on to the controllable device from a storage device coupled to the device controller.
